(19) United States
(12) Patent Application Publication
(10) Pub. No.: US 2017/0256819 A1
(43) Pub. Date: Sep. 7, 2017

(54) NONAQUEOUS ELECTROLYTIC SOLUTION AND ENERGY STORAGE DEVICE USING SAME

(71) Applicant: UBE INDUSTRIES, LTD., UBE-SHI (JP)

(72) Inventors: MASAHIDE KONDO, TAKAISHI-SHI (JP); YUICHI KOTOU, TAKAISHI-SHI (JP); HIROTO FUKATA, UBE-SHI (JP)

(73) Assignee: UBE INDUSTRIES, LTD., UBE-SHI (JP)

(21) Appl. No.: 15/446,655

(22) Filed: Mar. 1, 2017

(30) Foreign Application Priority Data
Mar. 1, 2016 (JP) 2016-039348

(51) Int. Cl. H01M 10/0567; H01M 10/0568; H01M 10/0525; H01M 10/0569

(52) U.S. Cl. CPC H01M 10/0567; H01M 10/0569; H01M 10/0568; H01M 10/0525; H01M 2300/0025; H01M 2300/0037

(57) ABSTRACT

Provided are a nonaqueous electrolytic solution having an electrolyte salt dissolved in a nonaqueous solvent, the nonaqueous electrolytic solution containing 0.01 to 4% by mass of a compound represented by the following general formula (I), and an energy storage device including the nonaqueous electrolytic solution:

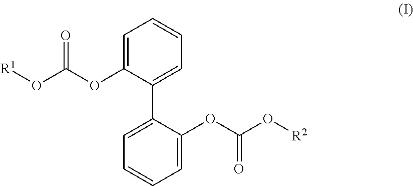

wherein R¹ and R² each independently represent a methyl group, an ethyl group, or a fluoroethyl group. The nonaqueous electrolytic solution and the energy storage device have improved high-temperature storage property and low-temperature cycle property.

### FIELD OF THE INVENTION

The present invention relates to a nonaqueous electrolytic solution which is excellent in electrochemical characteristics in a wide temperature range, in particular, excellent in high-temperature storage property and low-temperature cycle property, and also relates to an energy storage device including the nonaqueous electrolytic solution.

### BACKGROUND OF THE INVENTION

Energy storage devices, especially lithium secondary batteries have recently been widely used as a power source for a small-sized electronic device, such as a mobile telephone, a notebook personal computer, etc., and a power source for an electric vehicle and electric power storage. Among them, in the case of a lithium secondary battery that is used in a place in an unstable environment, such as those for an electric vehicle and electric power storage, the battery characteristics may be worsened early when the battery is used in midsummer or other high-temperature environments or in frigid midwinter or other low-temperature environments.

In a high-temperature environment, in particular, side reactions easily occur inside a battery and the electrolyte solution therein may be decomposed on a surface of the electrodes, worsening the storage property. On the other hand, in a low-temperature environment, since ionic conduction within a battery is lowered, the battery characteristics are hardly stabilized, significantly worsening the cycle property. Thus, the high-temperature storage property and the low-temperature cycle property become increasingly demanded, and there is a need for further improvement of the battery characteristics.

As used herein, the term “lithium secondary battery” is used for a concept also including a so-called “lithium ion secondary battery”.

A lithium secondary battery is mainly constituted of a positive electrode and a negative electrode, each containing a material capable of absorbing and releasing lithium ions, and a nonaqueous electrolytic solution containing a lithium salt and a nonaqueous solvent; and a carbonate, such as ethylene carbonate (EC), propylene carbonate (PC), etc., is used as the nonaqueous solvent.

In addition, a metal lithium, a metal compound capable of absorbing and releasing lithium ions (e.g., an elemental metal, a metal oxide, an alloy with lithium, etc.), and a carbon material are known as a material for the negative electrode of the lithium secondary battery. In particular, lithium secondary batteries in which a carbon material capable of absorbing and releasing lithium ions, for example, coke, artificial graphite, natural graphite, etc., is used as the carbon material are widely put into practical use.

For example, in a lithium secondary battery in which a high-crystalline carbon material, such as natural graphite, artificial graphite, etc., is used as a negative electrode material, a solvent in the nonaqueous electrolytic solution undergoes reductive decomposition on a negative electrode surface during charging to generate a decomposition product, which then deposits on the negative electrode surface and inhibits the electrochemical reaction desired for the battery. Accordingly, smooth absorption and release of lithium ions onto the negative electrode cannot be achieved and the low-temperature cycle property is apt to be worsened.

In a lithium secondary battery in which lithium metal, an alloy thereof, an elemental metal, such as tin, silicon, etc., or a metal oxide is used as a negative electrode material, in spite of the high initial capacity, fine particles are produced when the battery is used as an energy storage device, so that the reductive decomposition of the nonaqueous solvent occurs at an accelerated rate as compared with a negative electrode of a carbon material, thus greatly worsening the low-temperature cycle property.

On the other hand, in a lithium secondary battery in which, for example, LiCoO₂, LiMn2O₄, LiNiO₂, LiNi_{1/3}Mn_{1/3}Co_{1/3}O₂, or LiFePO₄ is used as a positive electrode material, the following fact has been found. A nonaqueous solvent in a nonaqueous electrolytic solution undergoes oxidative decomposition in a charged state at a high temperature, so that byproducts thus generated deposit on a positive electrode surface to form a high-resistance surface film, thus worsening the high-temperature storage property.

JP-A-2000-294279 discloses a nonaqueous electrolytic solution which contains a specific aromatic compound such as 4-fluorobiphenyl, etc., and Example 12 therein shows that when an electrolytic solution containing (1,1′-biphenyl)-4,4′-diyl dimethyl bis(carbonate) in a relatively large amount as much as 5% by weight is used, the rate of heat generation due to contact between LiCoO₂ as the positive electrode and the nonaqueous electrolytic solution can be suppressed.

JP-A-2002-280068 discloses a nonaqueous electrolyte secondary battery containing 2-biphenyl methyl carbonate or the like, and describes excellent safety thereof in an overcharged state.

### SUMMARY OF THE INVENTION

In intensive studies by the present inventors about performance of the nonaqueous electrolytic solutions in the aforementioned related art, the nonaqueous electrolytic solution of JP-A-2000-294279 and the nonaqueous electrolytic secondary battery of JP-A-2002-280068 did not satisfactorily perform the task of improving a capacity retention rate of an energy storage device stored at a high temperature and the task of improving a capacity retention rate in low-temperature cycles.

The present inventors conducted extensive studies for solving the above problems, and as a result, they found that the high-temperature storage property and low-temperature cycle property can be improved by incorporating a specific biphenyl compound, thereby completing the present invention.

A problem of the present invention is to provide a nonaqueous electrolytic solution capable of improving high-temperature storage property and low-temperature cycle property and an energy storage device including the nonaqueous electrolytic solution.

The present invention provides the following (1) and (2).
(1) A nonaqueous electrolytic solution having an electrolyte salt dissolved in a nonaqueous solvent, the nonaqueous electrolytic solution containing 0.01 to 4% by mass of a compound represented by the following general formula (I):

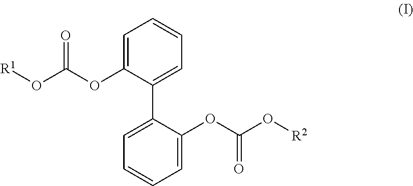

wherein R¹ and R² each independently represent a methyl group, an ethyl group, or a fluoroethyl group.
(2) An energy storage device including a positive electrode, a negative electrode, and a nonaqueous electrolytic solution having an electrolyte salt dissolved in a nonaqueous solvent, wherein the nonaqueous electrolytic solution is the nonaqueous electrolytic solution according to the above (1).

According to the present invention, a nonaqueous electrolytic solution capable of improving high-temperature storage property and low-temperature cycle property and an energy storage device, such as a lithium battery, etc., including the nonaqueous electrolytic solution can be provided.

### DETAILED DESCRIPTION OF THE INVENTION

### [Nonaqueous Electrolytic Solution]

The nonaqueous electrolytic solution of the present invention is a nonaqueous electrolytic solution having an electrolyte salt dissolved in a nonaqueous solvent, the nonaqueous electrolytic solution containing 0.01 to 4% by mass of a compound represented by the general formula (I).

Although the reason why the nonaqueous electrolytic solution of the present invention can improve high-temperature storage property and low-temperature cycle property remains to be fully clarified, it is inferred as follows.

In the specific biphenyl compound of the present invention represented by the general formula (I), the 2-position and the 2′-position of the biphenyl group in the structure are each substituted with an alkoxycarbonyloxy group. The alkoxycarbonyloxy groups substituted on the 2-position and the 2′-position of the biphenyl group function as a characteristic group, and have an effect of improving affinity of the biphenyl compound with the surfaces of active materials of the positive electrode and the negative electrode. Accordingly, by incorporating a specific amount of the specific biphenyl compound of the present invention into the nonaqueous electrolytic solution, the biphenyl compound is selectively adsorbed on the surfaces of positive and negative electrode active materials, thereby suppressing side reactions of the nonaqueous electrolytic solution with the positive and negative electrodes.

Regarding the effect, a compound in which the 3-position and the 3′-position, or the 4-position and the 4′-position, which are the meta position or the para position, respectively, of the biphenyl group are each substituted with an alkoxycarbonyloxy group does not achieve the same effect. That is, the effect is believed to be a specific effect achieved by incorporating the specific amount of the specific biphenyl compound of the present invention into the nonaqueous electrolytic solution.

### [Compound Represented by the General Formula (I)]

The compound contained in the nonaqueous electrolytic solution of the present invention is represented by the general formula (I).

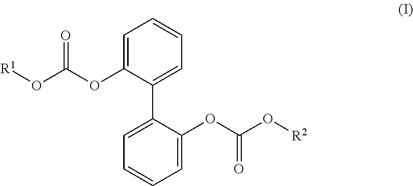

In the general formula (I), R¹ and R² each independently represent a methyl group, an ethyl group, or a fluoroethyl group.

Suitable examples of the fluoroethyl groups as R¹ and/or R² include a 2,2-difluoroethyl group and a 2,2,2-trifluoroethyl group.

As R¹ and R², a methyl group and an ethyl group are more preferred, and a methyl group is especially preferred.

Specific examples of the compound represented by the general formula (I) include the following Compounds 1 to 7.

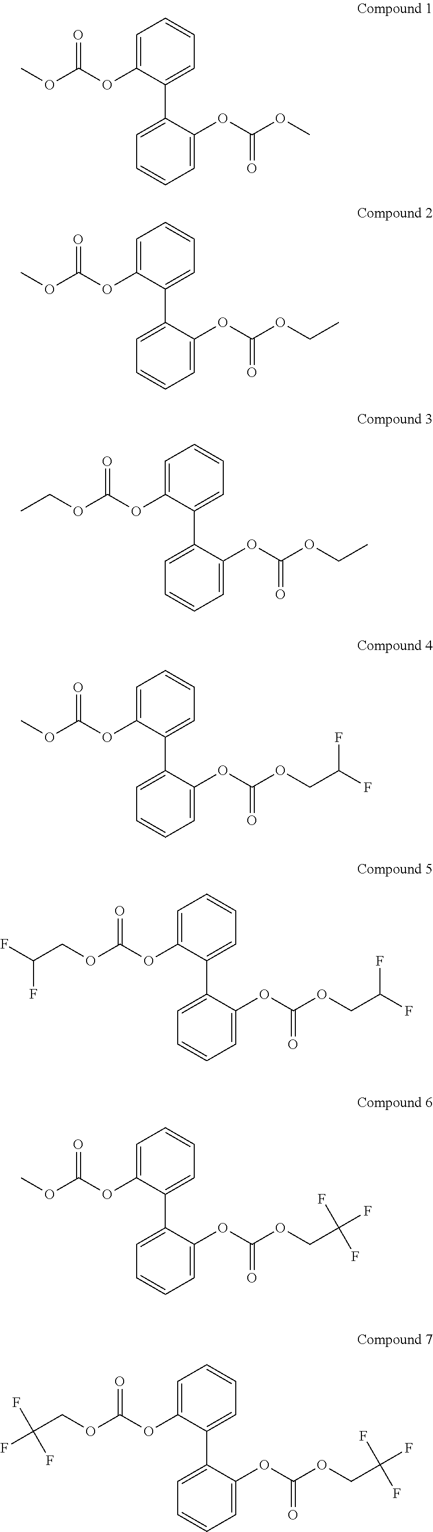

Among the above compounds, Compounds 1, 3, 5, and 7 are preferred, and one or two selected from (1,1′-biphenyl)-2,2′-diyl dimethyl bis(carbonate) (Compound 1) and (1,1′-biphenyl)-2,2′-diyl diethyl bis(carbonate) (Compound 3) are more preferred.

In the nonaqueous electrolytic solution of the present invention, compounds represented by the general formula (I), such as Compounds 1 to 7, may be used solely or in combination of two or more thereof, and the total content thereof is 0.01 to 4% by mass in the nonaqueous electrolytic solution. When the content is 4% by mass or less, there is less concern that a surface film excessively formed on an electrode worsens the cycle property of a battery used at high temperature. When the content is 0.01% by mass or more, the surface film is formed satisfactorily, resulting in enhancement of the effect of improving the cycle property of a battery used at high temperature. The content in the nonaqueous electrolytic solution is preferably 0.05% by mass or more, more preferably 0.3% by mass or more, and still more preferably 0.5% by mass or more. The upper limit thereof is preferably 3.8% by mass, more preferably 3.5% by mass, still more preferably 3% by mass, and especially preferably 2.5% by mass.

In the nonaqueous electrolytic solution of the present invention, when the compound represented by the general formula (I) is combined with a nonaqueous solvent and a electrolyte salt which are described below, and further with other additives, a specific effect is exhibited. Specifically, the effects of improving the high-temperature storage property and the low-temperature cycle property are synergistically increased.

### [Nonaqueous Solvent]

As the nonaqueous solvent used in the nonaqueous electrolytic solution of the present invention, one or more selected from the group consisting of a cyclic carbonate, a linear ester, a lactone, an ether, and an amide are suitably exemplified. In order to synergistically improve the electrochemical characteristics at high temperature, a linear ester is preferably included, a linear carbonate is more preferably included, both of a cyclic carbonate and a linear ester are still more preferably included, and both of a cyclic carbonate and a linear carbonate are especially preferably included.

Incidentally, the term “linear ester” is herein used as a concept including a linear carbonate and a linear carboxylate.

### <Cyclic Carbonate>

Suitable examples of the cyclic carbonate include one or more selected form the group consisting of ethylene carbonate (EC), propylene carbonate (PC), 1,2-butylene carbonate, 2,3-butylene carbonate, 4-fluoro-1,3-dioxolan-2-one (FEC), trans- or cis-4,5-difluoro-1,3-dioxolan-2-one (the both will be hereunder named generically as “DFEC”), vinylene carbonate (VC), vinyl ethylene carbonate (VEC), and 4-ethynyl-1,3-dioxolan-2-one (EEC). One or more selected from ethylene carbonate (EC), propylene carbonate (PC), 4-fluoro-1,3-dioxolan-2-one (FEC), vinylene carbonate (VC), and 4-ethynyl-1,3-dioxolan-2-one are more suitable.

Use of at least one of cyclic carbonates having an unsaturated bond, such as a carbon-carbon double bond, a carbon-carbon triple bond, etc., or a fluorine atom is preferred because the high-temperature storage property can be improved. It is more preferred that both of a cyclic carbonate having an unsaturated bond, such as a carbon-carbon double bond, a carbon-carbon triple bond, etc., and a cyclic carbonate having a fluorine atom are included. As the cyclic carbonate having an unsaturated bond, such as a carbon-carbon double bond, a carbon-carbon triple bond, etc., VC, VEC, and EEC are more preferred, and as the cyclic carbonate having a fluorine atom, FEC and DFEC are more preferred.

### (Content of Cyclic Carbonate)

The content of the cyclic carbonate having an unsaturated bond, such as a carbon-carbon double bond, a carbon-carbon triple bond, etc., is preferably 0.07% by volume or more, more preferably 0.2% by volume or more, and still more preferably 0.7% by volume or more relative to the total volume of the nonaqueous solvent, and the upper limit thereof is preferably 7% by volume, more preferably 4% by volume, and still more preferably 2.5% by volume. When the content falls within the above range, the high-temperature storage property can be further improved without impairing the lithium ion permeability, and hence, such is preferred.

The content of the cyclic carbonate having a fluorine atom is preferably 0.07% by volume or more, more preferably 4% by volume or more, and still more preferably 6% by volume or more relative to the total volume of the nonaqueous solvent, and the upper limit thereof is 35% by volume, more preferably 25% by volume, and still more preferably 15% by volume. When the content falls within the above range, the high-temperature storage property can be further improved without impairing the lithium ion permeability, and hence, such is preferred.

When the nonaqueous solvent includes both the cyclic carbonate having an unsaturated bond, such as a carbon-carbon double bond, a carbon-carbon triple bond, etc., and the cyclic carbonate having a fluorine atom, the proportion of the content of the cyclic carbonate having an unsaturated bond, such as a carbon-carbon double bond, a carbon-carbon triple bond, etc., to the content of the cyclic carbonate having a fluorine atom is preferably 0.2% by volume or more, more preferably 3% by volume or more, and still more preferably 7% by volume or more, and the upper limit thereof is preferably 35% by volume, more preferably 25% by volume, and still more preferably 15% by volume. When the proportion of the contents falls within the above range, the high-temperature storage property can be improved without impairing the lithium ion permeability, and hence, such is especially preferred.

When the nonaqueous solvent includes both ethylene carbonate and the cyclic carbonate having an unsaturated bond, such as a carbon-carbon double bond, a carbon-carbon triple bond, etc., the high-temperature storage property can be improved, and hence, such is preferred. The content of ethylene carbonate and the cyclic carbonate having an unsaturated bond, such as a carbon-carbon double bond, a carbon-carbon triple bond, etc., is preferably 3% by volume or more, more preferably 5% by volume or more, and still more preferably 7% by volume or more relative to the total volume of the nonaqueous solvent, and the upper limit thereof is preferably 45% by volume, more preferably 35% by volume, and still more preferably 25% by volume.

These solvents may be used solely, but in the case where a combination of two or more of the solvents is used, the high-temperature storage property can be improved, and hence, such is preferred. Use of a combination of three or more thereof is especially preferred. As suitable combinations of these cyclic carbonates, combinations of EC and PC; EC and VC; PC and VC; VC and FEC; EC and FEC; PC and FEC; FEC and DFEC; EC and DFEC; PC and DFEC; VC and DFEC; VEC and DFEC; VC and EEC; EC and EEC; EC, PC and VC; EC, PC and FEC; EC, VC and FEC; EC, VC and VEC; EC, VC and EEC; EC, EEC and FEC; PC, VC and FEC; EC, VC and DFEC; PC, VC and DFEC; EC, PC, VC and FEC; EC, PC, VC and DFEC; and the like are preferred. Among the foregoing combinations, combinations of EC and VC; EC and FEC; PC and FEC; EC, PC and VC; EC, PC and FEC; EC, VC and FEC; EC, VC and EEC; EC, EEC and FEC; PC, VC and FEC; and EC, PC, VC and FEC are more preferred.

### <Linear Ester>

Suitable examples of the linear ester include: one or more asymmetric linear carbonates selected from the group consisting of methyl ethyl carbonate (MEC), methyl propyl carbonate (MPC), methyl isopropyl carbonate (MIPC), methyl butyl carbonate, and ethyl propyl carbonate; one or more symmetric linear carbonates selected from the group consisting of dimethyl carbonate (DMC), diethyl carbonate (DEC), dipropyl carbonate, and dibutyl carbonate; and one or more linear carboxylate selected from the group consisting of a pivalate, such as methyl pivalate, ethyl pivalate, propyl pivalate, etc., methyl propionate, ethyl propionate (EP), propyl propionate, methyl acetate, and ethyl acetate (EA).

Among the linear esters, a linear ester having a methyl group selected from the group consisting of dimethyl carbonate (DMC), methyl ethyl carbonate (MEC), methyl propyl carbonate (MPC), methyl isopropyl carbonate (MIPC), methyl butyl carbonate, methyl propionate, methyl acetate, and ethyl acetate (EA) is preferred, and a linear carbonate having a methyl group is especially preferred.

From the viewpoint of improving the electrochemical characteristics at high voltage, at least one linear ester in which at least one hydrogen atom is substituted with a fluorine atom is preferably included.

Suitable specific examples of the linear ester in which at least one hydrogen atom is substituted with a fluorine atom include one or more selected from the group consisting of 2,2-difluoroethyl acetate (DFEA), 2,2,2-trifluoroethyl acetate (TFEA), 2,2-difluoroethyl propionate, 2,2,2-trifluoroethyl propionate, methyl 2,2-difluoropropionate, methyl 3,3,3-trifluoropropionate, methyl (2,2-difluoroethyl) carbonate (MDFEC), and methyl (2,2,2-trifluoroethyl) carbonate (MTFEC).

Among them, from the viewpoint of improving the electrochemical characteristics in a high-temperature environment, one or more selected from the group consisting of 2,2,2-trifluoroethyl acetate, 2,2-difluoroethyl acetate, methyl 3,3,3-trifluoropropionate, methyl (2,2-difluoroethyl) carbonate, and methyl (2,2,2-trifluoroethyl) carbonate are more preferred.

In the case of using a linear carbonate, it is preferred that two or more thereof is used. Furthermore, it is more preferred that both the symmetric linear carbonate and the asymmetric linear carbonate are included, and it is still more preferred that the content of the symmetric linear carbonate is larger than the content of the asymmetric linear carbonate.

### (Content of Linear Ester)

Although the content of the linear ester is not particularly limited, it is preferred that the linear ester is used in an amount in the range of from 60 to 90% by volume relative to the total volume of the nonaqueous solvent. When the content is 60% by volume or more, the viscosity of the nonaqueous electrolytic solution is not excessively increased, and when it is 90% by volume or less, there is less concern that the electroconductivity of the nonaqueous electrolytic solution is lowered to worsen the low-temperature cycle property, and hence, it is preferred that the content of the linear ester falls within the aforementioned range.

The proportion of the volume of the symmetric linear carbonate in the linear carbonate is preferably 51% by volume or more, and more preferably 55% by volume or more. The upper limit thereof is preferably 95% by volume, and more preferably 85% by volume. It is especially preferred that dimethyl carbonate (DMC) is included in the symmetric linear carbonate. In addition, it is more preferred that the asymmetric linear carbonate has a methyl group, and methyl ethyl carbonate (MEC) is especially preferred. The aforementioned case is preferred because the low-temperature cycle property is further improved.

From the viewpoint of improving the electrochemical characteristics at high temperature, the ratio of the cyclic carbonate to the linear ester (volume ratio) is preferably 10/90 to 45/55, more preferably 15/85 to 40/60, and especially preferably 20/80 to 35/65.

### (Other Nonaqueous Solvents)

In the present invention, another nonaqueous solvent may be added in addition to the aforementioned nonaqueous solvent.

Examples of this other nonaqueous solvent include one or more selected from the group consisting of a cyclic ether, such as tetrahydrofuran, 2-methyltetrahydrofuran, 1,4-dioxane, etc.; a linear ether, such as 1,2-dimethoxyethane, 1,2-diethoxyethane, 1,2-dibutoxyethane, etc.; an amide, such as dimethylformamide, etc.; a sulfone, such as sulfolane, etc.; and a lactone, such as γ-butyrolactone (GBL), γ-valerolactone, α-angelicalactone, etc.

The content of this other nonaqueous solvent is generally 1% by volume or more, preferably 2% by volume or more relative to the total volume of the nonaqueous solvent, and generally 40% by volume or less, preferably 30% by volume or less, and still more preferably 20% by volume or less.

In general, the nonaqueous solvents are used in admixture for the purpose of attaining appropriate physical properties. Suitable examples of the combination thereof include a combination of a cyclic carbonate and a linear carbonate; a combination of a cyclic carbonate and a linear carboxylate; a combination of a cyclic carbonate, a linear ester (especially, a linear carbonate), and a lactone; a combination of a cyclic carbonate, a linear ester (especially, a linear carbonate), and an ether; a combination of a cyclic carbonate, a linear carbonate, and a linear carboxylate; and the like. A combination of a cyclic carbonate, a linear ester, and a lactone is more preferred, and among lactones, use of γ-butyrolactone (GBL) is still more preferred.

### (Other Additives)

For the purpose of further improving the high-temperature storage property, it is preferred that another additive is further added in the nonaqueous electrolytic solution.

Specific examples of this other additive include the following compounds (A) to (I).

(A) One or more nitriles selected from the group consisting of acetonitrile, propionitrile, succinonitrile, glutaronitrile, adiponitrile, pimelonitrile, suberonitrile, and sebaconitrile.

(B) An aromatic compound having a branched alkyl group, such as cyclohexylbenzene, tert-butylbenzene, tert-amylbenzene, 1-fluoro-4-tert-butylbenzene, etc.; and an aromatic compound, such as biphenyl, terphenyl (o-, m-, p-form), a fluorobenzene, methyl phenyl carbonate, ethyl phenyl carbonate, diphenyl carbonate, etc.

(C) One or more isocyanate compounds selected from the group consisting of methyl isocyanate, ethyl isocyanate, butyl isocyanate, phenyl isocyanate, tetramethylene diisocyanate, hexamethylene diisocyanate, octamethylene diisocyanate, 1,4-phenylene diisocyanate, 2-isocyanatoethyl acrylate, and 2-isocyanatoethyl methacrylate.

(D) One or more triple bond-containing compounds selected from the group consisting of 2-propynyl methyl carbonate, 2-propynyl acetate, 2-propynyl formate, 2-propynyl methacrylate, 2-propynyl methanesulfonate, 2-propynyl vinylsulfonate, 2-propynyl 2-(methanesulfonyloxy)propionate, di(2-propynyl) oxalate, 2-butyne-1,4-diyl dimethanesulfonate, and 2-butyne-1,4-diyl diformate.

(E) One or more cyclic or linear S═O group-containing compounds selected from the group consisting of: a sultone, such as 1,3-propanesultone, 1,3-butanesultone, 2,4-butanesultone, 1,4-butanesultone, 1,3-propenesultone, 2,2-dioxide-1,2-oxathiolane-4-yl acetate, etc.; a cyclic sulfate, such as ethylene sulfite, etc.; a cyclic sulfate, such as ethylene sulfate, etc.; a sulfonic acid ester, such as butane-2,3-diyl dimethanesulfonate, butane-1,4-diyl dimethanesulfonate, methylene methanedisulfonate, etc.; and a vinylsulfone compound, such as divinylsulfone, 1,2-bis(vinylsulfonyl)ethane, bis(2-vinylsulfonylethyl) ether, etc.

(F) One or more cyclic acetal compounds selected from the group consisting of 1,3-dioxolane, 1,3-dioxane, and 1,3,5-trioxane. The kind of the cyclic acetal compound is not particularly limited, as long as it is a compound having an “acetal group” in the molecule.

(G) One or more phosphorus-containing compounds selected from the group consisting of trimethyl phosphate, tributyl phosphate, trioctyl phosphate, tris(2,2,2-trifluoroethyl) phosphate, ethyl 2-(diethoxyphosphoryl)acetate, and 2-propynyl 2-(diethoxyphosphoryl)acetate.

(H) One or more carboxylic acid anhydrides selected from the group consisting of a linear carboxylic acid anhydride, such as acetic anhydride, propionic anhydride, etc.; and a cyclic acid anhydride, such as succinic anhydride, maleic anhydride, 3-allylsuccinic anhydride, glutaric anhydride, itaconic anhydride, 3-sulfo-propionic anhydride, etc. The kind of the carboxylic acid anhydride is not particularly limited, as long as it is a compound having a “C(═O)—O—C(═O) group” in the molecule.

(I) One or more cyclic phosphazene compounds selected from the group consisting of methoxypentafluorocyclotriphosphazene, ethoxypentafluorocyclotriphosphazene, phenoxypentafluorocyclotriphosphazene, ethoxyheptafluorocyclotetraphosphazene, etc. The kind of the cyclic posphazene compound is not particularly limited, as long as it is a compound having an “N═P—N group” in the molecule.

Among the foregoing compounds, when at least one selected from the group consisting of the nitrile (A), the aromatic compound (B), and the isocyanate compound (C) is contained, the electrochemical characteristics at high temperature are further improved, and hence, such is preferred.

Among the nitriles (A), one or more selected from the group consisting of succinonitrile, glutaronitrile, adiponitrile, and pimelonitrile are more preferred.

Among the aromatic compounds (B), one or more selected from the group consisting of biphenyl, terphenyl (o-, m-, p-form), fluorobenzene, cyclohexylbenzene, tert-butylbenzene, and tert-amylbenzene are more preferred; and one or more selected from the group consisting of biphenyl, o-terphenyl, fluorobenzene, cyclohexylbenzene, and tert-amylbenzene are especially preferred.

Among the isocyanate compounds (C), one or more selected from the group consisting of hexamethylene diisocyanate, octamethylene diisocyanate, 2-isocyanatoethyl acrylate, and 2-isocyanatoethyl methacrylate are more preferred.

The content of the compounds (A) to (C) is preferably 0.01 to 7% by mass in the nonaqueous electrolytic solution. When the content falls within this range, a surface film is formed sufficiently but not excessively in the thickness, and the high-temperature storage property can be improved. The content is more preferably 0.05% by mass or more, and still more preferably 0.1% by mass or more in the nonaqueous electrolytic solution, and the upper limit thereof is more preferably 5% by mass, and still more preferably 3% by mass.

When the triple bond-containing compound (D), the cyclic or linear S═O group-containing compound (E) selected from the group consisting of a sultone, a cyclic sulfite, a sulfonic acid ester, and a vinylsulfone, the cyclic acetal compound (F), the phosphorus-containing compound (G), the cyclic acid anhydride (H), or the cyclic phosphazene compound (I) is contained, the high-temperature storage property can be improved, and hence, such is preferred.

As the triple bond-containing compound (D), one or more selected from the group consisting of 2-propynyl methyl carbonate, 2-propynyl methacrylate, 2-propynyl methanesulfonate, 2-propynyl vinylsulfonate, di(2-propynyl) oxalate, and 2-butyne-1,4-diyl dimethanesulfonate are preferred, and one or more selected from the group consisting of 2-propynyl methanesulfonate, 2-propynyl vinylsulfonate, di(2-propynyl) oxalate, and 2-butyne-1,4-diyl dimethanesulfonate are more preferred.

It is preferred that a cyclic or linear S═O group-containing compound (E) (excluding a triple bond-containing compound) selected from the group consisting of a sultone, a cyclic sulfite, a cyclic sulfate, a sulfonic acid ester, and a vinyl sulfone is used.

As the cyclic S═O group-containing compound, one or more selected from the group consisting of 1,3-propanesultone, 1,3-butanesultone, 1,4-butanesultone, 2,4-butanesultone, 1,3-propenesultone, 2,2-dioxide-1,2-oxathiolane-4-yl acetate, methylene methanedisulfonate, ethylene sulfite, and ethylene sulfate are suitably exemplified.

As the linear S═O group-containing compound, one or more selected from the group consisting of butane-2,3-diyl dimethanesulfonate, butane-1,4-diyl dimethanesulfonate, dimethyl methanedisulfonate, pentafluorophenyl methanesulfonate, divinylsulfone, and bis(2-vinylsulfonylethyl)ether are suitably exemplified.

Among the cyclic or linear S═O group-containing compounds, one or more selected from the group consisting of 1,3-propanesultone, 1,4-butanesultone, 2,4-butanesultone, 2,2-dioxide-1,2-oxathiolane-4-yl acetate, ethylene sulfate, pentafluorophenyl methanesulfonate, and divinylsulfone are still more preferred.

As the cyclic acetal compound (F), 1,3-dioxolane and 1,3-dioxane are preferred, and 1,3-dioxane is more preferred.

As the phosphorus-containing compound (G), tris(2,2,2-trifluoroethyl) phosphate, ethyl 2-(diethoxyphosphoryl)acetate, and 2-propynyl 2-(diethoxyphosphoryl)acetate are preferred, and 2-propynyl 2-(diethoxyphosphoryl)acetate is more preferred.

As the cyclic acid anhydride (H), succinic anhydride, maleic anhydride, and 3-allylsuccinic anhydride are preferred, and succinic anhydride and 3-allylsuccinic anhydride are more preferred.

As the cyclic phosphazene compound (I), a cyclic phosphazene compound, such as methoxypentafluorocyclotriphosphazene, ethoxypentafluorocyclotriphosphazene, phenoxypentafluorocyclotriphosphazene, etc., are preferred, and methoxypentafluorocyclotriphosphazene and ethoxypentafluorocyclotriphosphazene are more preferred.

The content of the compounds (D) to (I) is preferably 0.001 to 5% by mass in the nonaqueous electrolytic solution. When the content falls within this range, a surface film is formed sufficiently but not excessively in the thickness, and the high-temperature storage property can be further improved. The content is more preferably 0.01% by mass or more, and still more preferably 0.1% by mass or more in the nonaqueous electrolytic solution, and the upper limit thereof is more preferably 3% by mass, and still more preferably 2% by mass.

### (Lithium Salt)

For the purpose of further improving the electrochemical characteristics at high temperature, the nonaqueous electrolytic solution preferably further contains one or more lithium salts selected from the group consisting of a lithium salt having a oxalate structure, a lithium salt having a phosphate structure, a lithium salt having a S═O group, and a lithium salt composed of a lithium cation with an ether compound as a ligand and a difluorophosphate anion.

Suitable specific examples of the lithium salt include: one or more lithium salts having a oxalate structure selected from the group consisting of lithium bis(oxalate)borate [LiBOB], lithium difluoro(oxalate)borate [LiDFOB], lithium tetrafluoro(oxalate)phosphate [LiTFOP], and lithium difluorobis(oxalate)phosphate [LiDFOP]; one or more lithium salts having a phosphate structure selected from the group consisting of LiPO₂F₂ and Li₂PO₃F; and one or more lithium salts having a S═O group selected from the group consisting of lithium trifluoro((methanesulfonyl)oxy)borate [LiTFMSB], lithium pentafluoro((methanesulfonyl)oxy)phosphate [LiPFMSP], lithium methylsulfate [LMS], lithium ethylsulfate [LES], lithium 2,2,2-trifluoroethylsulfate [LFES], and FSO₃Li; a lithium salt represented by the following formula (1) or (2) which is composed of a lithium cation with an ether compound selected from 2,5,8,11-tetraoxadodecane (hereinunder also referred to as “TOD”) and 2,5,8,11,14-pentaoxapentadecane (hereinunder also referred to as “POP”) as a ligand and a difluorophosphate anion.

[Li₂(TOD)]²⁺[(PO₂F₂).]₂ (1)

[Li₂(POP)]²⁺[(PO₂F₂).]₂ (2)

Among the above lithium salts, LiBOB, LiDFOB, LiTFOP, LiDFOP, LiPO₂F₂, LiTFMSB, LMS, LES, LFES, FSO₃Li, and bis(difluorophosphoryl)(2,5,8,11-tetraoxadodecane)dilithium (LiTOD) represented by the general formula (1) are more preferred, and LiDFOB, LiTFOP, and LiDFOP are especially preferred.

The total content of the lithium salt in the nonaqueous electrolytic solution is preferably 0.001 M (mol/L) to 0.5 M (mol/L). When the proportion falls within this range, the high-temperature storage property can be further improved. The proportion is more preferably 0.01 M or more, still more preferably 0.03M or more, and especially preferably 0.04 M or more. The upper limit thereof is more preferably 0.4 M, and especially preferably 0.2 M.

### (Electrolyte Salt)

As suitable examples of the electrolyte salt for use in the present invention, the following lithium salts are mentioned.

Suitable examples of the lithium salt include at least one lithium salt selected from the group consisting of; an inorganic lithium salt, such as LiPF₆, LiBF₄, LiClO₄, LiN(SO₂F)₂[LiFSI], etc.; a lithium salt having a linear fluoroalkyl group, such as LiN(SO₂CF₃)₂, LiN(SO₂C₂F₅)₂, LiCF₃SO₃, LiC(SO₂CF₃)₃, LiPF₄(CF₃)₂, LiPF₃(C₂F₅)₃, LiPF₃(CF₃)₃, LiPF₃(iso-C₃F₇)₃, LiPF₅(iso-C₃F₇), etc.; and a lithium salt having a cyclic fuloroalkylene chain, such as (CF₂)₂(SO₂)₂NLi, (CF₂)₃(SO₂)₂NLi, etc. The compounds may be used solely or in mixture of two or more thereof.

Among them, one or more selected from the group consisting of LiPF₆, LiN(SO₂F)₂[LiFSI], LiN(SO₂CF₃)₂, and LiN(SO₂C₂F₅)₂ are preferred, and LiPF₆ is most preferred.

The concentration of the electrolyte salt in the nonaqueous electrolytic solution is, in general, preferably 0.3 M or more, more preferably 0.7 M or more, and still more preferably 1.1 M or more. The upper limit thereof is preferably 2.5 M, more preferably 2 M, and still more preferably 1.6 M.

As for a suitable combination of the electrolyte salts, the nonaqueous electrolytic solution containing LiPF₆ and further containing at least one lithium salt selected from the group consisting of LiBF₄, LiN(SO₂CF₃)₂, and LiN(SO₂F)₂ [LiFSI] is preferred. When the proportion of lithium salts other than LiPF₆ in the nonaqueous electrolytic solution is 0.001 M or more, the low-temperature cycle property can be improved, and when the proportion is 1 M or less, there is less concern of worsening the low-temperature cycle property, and hence, such are preferred. The proportion is preferably 0.01 M or more, especially preferably 0.03 M or more, and the most preferably 0.04 M or more. The upper limit thereof is preferably 0.8 M, more preferably 0.6 M, and especially preferably 0.4 M.

### [Production of Nonaqueous Electrolytic Solution]

The nonaqueous electrolytic solution of the present invention may be produced, for example, by mixing the aforementioned nonaqueous solvents, adding the aforementioned electrolyte salt thereto, and adding the compound represented by the general formula (I) to the resulting nonaqueous electrolytic solution.

At this time, the nonaqueous solvent to be used and the compound represented by the general formula (I) to be added to the nonaqueous electrolytic solution are preferably purified in advance to decrease impurities as far as possible to the extent that the productivity is not remarkably worsened.

The nonaqueous electrolytic solution of the present invention may be used in the following first to fourth energy storage devices, and the nonaqueous electrolyte salt may be used not only in the form of a liquid but also in the form of a gel. Furthermore, the nonaqueous electrolytic solution of the present invention may also be used for a solid polymer electrolyte. Above all, the nonaqueous electrolytic solution is preferably used in the first energy storage device using a lithium salt as the electrolyte salt (i.e., for a lithium battery) or in the fourth energy storage device (i.e., for a lithium ion capacitor), and more preferably used in a lithium battery. The nonaqueous electrolytic solution is most suitably used in a lithium secondary battery.

### [First Energy Storage Device (Lithium Battery)]

The lithium battery which is a first energy storage device is a generic name for a lithium primary battery and a lithium secondary battery. The term “lithium secondary battery” is used herein as a concept also including a so-called lithium ion secondary battery.

The lithium battery of the present invention includes a positive electrode, a negative electrode, and the aforementioned nonaqueous electrolytic solution having an electrolyte salt dissolved in a nonaqueous solvent. Other constitutional members than the nonaqueous electrolytic solution, such as the positive electrode, the negative electrode, etc., may be used without being particularly limited.

For example, as a positive electrode active material for a lithium secondary battery, a complex metal oxide containing lithium and one or more selected from the group consisting of cobalt, manganese, and nickel is used. The positive electrode active materials may be used solely or in combination of two or more thereof.

Suitable examples of the lithium complex metal oxide include one or more selected from the group consisting of LiCoO₂, LiCo₁₋ₓMₓO₂ (wherein M represents one or more elements selected from the group consisting of Sn, Mg, Fe, Ti, Al, Zr, Cr, V, Ga, Zn, and Cu, 0.001≦x≦0.05), LiMn₂O₄, LiNiO₂, LiCo₁₋ₓNiₓO₂ (0.01<x<1), LiCo_{1/3}Ni_{1/3}Mn_{1/3}O₂, LiNi_{0.5}Mn_{0.3}Co_{0.2}O₂, LiNi_{0.6}Mn_{0.2}Co_{0.2}O₂, LiNi_{0.8}Mn_{0.1}Co_{0.1}O₂, LiNi_{0.8}Co_{0.15}Al_{0.05}O₂, a solid solution of Li₂MnO₃ and LiMO₂ (wherein M represents a transition metal, such as Co, Ni, Mn, Fe, etc.), and LiNi_{1/2}Mn_{3/2}O₄. These materials may be used as a combination, such as a combination of LiCoO₂ and LiMn₂O₄, a combination of LiCoO₂ and LiNiO₂, a combination of LiMn₂O₄ and LiNiO₂, etc.

In general, the use of the lithium complex metal oxide capable of acting at a high charging voltage is liable to worsen the electrochemical characteristics in a high-temperature environment due to a reaction with the electrolytic solution during charging. However, in the lithium secondary battery according to the present invention, the worsening of the electrochemical characteristics may be suppressed.

In particular, when a positive electrode active material containing Ni is used, the resistance of the battery generally tends to be increased due to decomposition of nonaqueous solvent on the positive electrode surface caused by the catalytic action of Ni. The lithium secondary battery according to the present invention is preferred because the worsening of the high-temperature storage property can be suppressed. In particular, in the case of using a positive electrode active material having a proportion of the atomic concentration of Ni of more than 30 atomic % relative to the total atomic concentration of all the transition metal elements in the positive electrode active material, the aforementioned effect is notable, and hence, such is preferred. The proportion is more preferably 40 atomic % or more, and especially preferably 50 atomic % or more. Suitable specific examples include one or more selected from the group consisting of LiCo_{1/3}Ni_{1/3}Mn_{1/3}O₂, LiNi_{0.5}Mn_{0.3}Co_{0.2}O₂, LiNi_{0.6}Mn_{0.2}Co_{0.2}O₂, LiNi_{0.8}Mn_{0.1}Co_{0.1}O₂, and LiNi_{0.8}Co_{0.5}Al_{0.05}O₂.

Furthermore, a lithium-containing olivine-type phosphate may also be used as the positive electrode active material. In particular, a lithium-containing olivine-type phosphate containing one or more selected from the group consisting of iron, cobalt, nickel, and manganese is preferred. Specific examples thereof include LiFePO₄, LiCoPO₄, LiNiPO₄, LiMnPO₄, LiFe₁₋ₓMnₓPO₄ (0.1<x<0.9), and the like.

A part of such a lithium-containing olivine-type phosphate may be substituted with other element. A part of iron, cobalt, nickel, or manganese may be substituted with one or more elements selected from the group consisting of Co, Mn, Ni, Mg, Al, B, Ti, V, Nb, Cu, Zn, Mo, Ca, Sr, W and Zr, or the lithium-containing olivine-type phosphate may be coated with a compound containing any of these other elements or with a carbon material. Among them, LiFePO₄ and LiMnPO₄ are preferred.

The lithium-containing olivine-type phosphate may also be used, for example, in admixture with the aforementioned positive electrode active material.

Since the lithium-containing olivine-type phosphate forms a stable phosphate (PO₄) structure and is excellent in thermal stability in a charged state, the electrochemical characteristics may be improved over a wide range of temperature.

Examples of the positive electrode for a lithium primary battery include: an oxide or chalcogen compound of one or more metal elements, such as CuO, Cu₂O, Ag₂O, Ag₂CrO₄, CuS, CuSO₄, TiO₂, TiS₂, SiO₂, SnO, V₂O₅, V₆O₁₂, VOₓ, Nb₂O₅, Bi₂O₃, Bi₂Pb₂O₅, Sb₂O₃, CrO₃, Cr2O₃, MoO₃, WO₃, SeO₂, MnO₂, Mn₂O₃, Fe₂O₃, FeO, Fe₃O₄, Ni₂O₃, NiO, CoO₃, CoO, etc.; a sulfur compound, such as SO₂, SOCl₂, etc.; a carbon fluoride (graphite fluoride) represented by the general formula (CFₓ)ₙ; and the like. Among them, MnO₂, V₂O₅, graphite fluoride, and the like are preferred.

An electroconductive agent of the positive electrode is not particularly limited so long as it is an electron-conductive material that does not undergo chemical change. Examples thereof include graphites, such as natural graphite (e.g., flaky graphite, etc.), artificial graphite, etc.; and carbon blacks, such as acetylene black, Ketjen black, channel black, furnace black, lamp black, thermal black, etc.; and the like. The graphite and the carbon black may be appropriately used in admixture. An amount of the electroconductive agent added to the positive electrode mixture is preferably 1 to 10% by mass, and especially preferably 2 to 5% by mass.

The positive electrode may be produced in such a manner that the aforementioned positive electrode active material is mixed with an electroconductive agent, such as acetylene black, carbon black, etc., and then mixed with a binder, such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), an ethylene-propylene-diene terpolymer, etc., to which is then added a high-boiling point solvent, such as 1-methyl-2-pyrrolidone, etc., followed by kneading to provide a positive electrode mixture, and the positive electrode mixture is applied onto a collector, such as an aluminum foil, a stainless steel-made lath plate, etc., dried, shaped under pressure, and then heat-treated in vacuum at a temperature of about 50° C. to 250° C. for about 2 hours.

The density of the positive electrode except for the collector is generally 1.5 g/cm³ or more, and for the purpose of further increasing the capacity of the battery, the density is preferably 2 g/cm³ or more, more preferably 3 g/cm³ or more, and still more preferably 3.6 g/cm³ or more. The upper limit thereof is preferably 4 g/cm³.

As a negative electrode active material for a lithium secondary battery, one or more selected from metal lithium, a lithium alloy, a carbon material capable of absorbing and releasing lithium ions [e.g., graphitizable carbon, non-graphitizable carbon having a spacing of a (002) plane of 0.37 nm or more, graphite having a spacing of a (002) plane of 0.34 nm or less, etc.], elemental tin, a tin compound, elemental silicon, a silicon compound, and a lithium titanate compound, such as Li₄Ti₅O₁₂, etc., are preferred.

Among them, in the ability of absorbing and releasing lithium ions, the use of a high-crystalline carbon material, such as artificial graphite, natural graphite, etc., is more preferred, and the use of a carbon material having a graphite-type crystal structure with a lattice (002) spacing (d₀₀₂) of 0.340 nm (nanometers) or less, and especially from 0.335 to 0.337 nm, is especially preferred.

In particular, the use of artificial graphite particles having a bulky structure containing plural flattened graphite fine particles that are aggregated or bonded non-parallel to each other, or graphite particles produced through a spheroidizing treatment of flaky natural graphite particles by repeatedly applying thereon a mechanical action, such as a compression force, a friction force, a shear force, etc., is preferred for the reason as follows. That is, in this case, when a negative electrode sheet is shaped under pressure to such an extent that the density of the negative electrode except for the collector is 1.5 g/cm³ or more, the ratio I(110)/I(004) of the peak intensity I(110) of the (110) plane to the peak intensity I(004) of the (004) plane of the graphite crystal determined through X-ray diffractometry of the negative electrode sheet is 0.01 or more, and then the amount of the metals eluted from the positive electrode active material and the high-temperature storage property are thus further improved, and hence such is preferred. The ratio I(110)/I(004) is more preferably 0.05 or more, and still more preferably 0.1 or more. The upper limit is preferably 0.5, and more preferably 0.3 because an excessive treatment may cause worsening of the crystallinity to lower the discharge capacity of the battery.

When the high-crystalline carbon material (core material) is coated with a carbon material having lower crystallinity than the core material, the high-temperature storage property becomes further favorable, and hence, such is preferred. The crystallinity of the carbon material in the coating may be confirmed by a transmission electron microscope (TEM).

When the high-crystalline carbon material is used, there is a general tendency that it reacts with the nonaqueous electrolytic solution during charging, thereby worsening the high-temperature storage property due to an increase of interfacial resistance. However, in the lithium secondary battery according to the present invention, the high-temperature storage property becomes favorable.

Examples of the metal compound capable of absorbing and releasing lithium ions as a negative electrode active material include a compound containing at least one metal element, such as Si, Ge, Sn, Pb, P, Sb, Bi, Al, Ga, In, Ti, Mn, Fe, Co, Ni, Cu, Zn, Ag, Mg, Sr, Ba, etc. The metal compound may be in any form including an elemental metal, an alloy, an oxide, a nitride, a sulfide, a boride, an alloy with lithium, and the like, and any one of an elemental metal, an alloy, an oxide, and an alloy with lithium is preferred because the battery capacity can be increased. Above all, a compound containing at least one element selected from the group consisting of Si, Ge, and Sn is preferred, and a compound containing at least one element selected from the group consisting of Si and Sn is more preferred because the battery capacity can be increased.

The negative electrode may be produced in such a manner that the same electroconductive agent, binder, and high-boiling point solvent as in the production of the positive electrode as described above are kneaded to provide a negative electrode mixture, and the negative electrode mixture is then applied on a collector, such as a copper foil, etc., dried, shaped under pressure, and then heat-treated in vacuum at a temperature of about 50° C. to 250° C. for about 2 hours.

The density of the negative electrode except for the collector is generally 1.1 g/cm³ or more, and for the purpose of further increasing the capacity of the battery, the density is preferably 1.5 g/cm³ or more, and especially preferably 1.7 g/cm³ or more. The upper limit thereof is preferably 2 g/cm³.

Examples of the negative electrode active material for a lithium primary battery include metal lithium and a lithium alloy.

The structure of the lithium battery is not particularly limited, and the battery may be a coin-type battery, a cylinder-type battery, a prismatic battery, a laminate-type battery, or the like, each having a single-layered or multi-layered separator.

The separator for the battery is not particularly limited, and a single-layered or laminated micro-porous film of a polyolefin, such as polypropylene, polyethylene, an ethylene-propylene copolymer, etc., a woven fabric, a nonwoven fabric, and the like may be used.

As the laminate of a polyolefin, a laminate of polyethylene and polypropylene is preferred, and three-layered structure of polypropylene/polyethylene/polypropylene is more preferred.

The thickness of the separator is preferably 2 μm or more, more preferably 3 μm or more, and still more preferably 4 μm or more, and the upper limit is 30 μm, preferably 20 μm, and more preferably 15 μm.

The lithium secondary battery in the present invention is excellent in the high-temperature cycle property even when the final charging voltage is 4.2 V or more, particularly 4.3 V or more, and furthermore, the property is favorable even at 4.4 V or more. The final discharging voltage may be generally 2.8 V or more, and further 2.5 V or more, and the final discharging voltage of the lithium secondary battery in the present invention may be 2.0 V or more. The electric current is not particularly limited, and in general, the battery may be used within the range of from 0.1 to 30 C. The lithium battery in the present invention may be charged and discharged at from −40 to 100° C., and preferably from −10 to 80° C.

In the present invention, as a countermeasure against increase in the internal pressure of the lithium battery, there may also be adopted such a method that a safety valve is provided in a battery cap, or a cutout is provided in a battery can, a gasket, or other members. As a safety countermeasure for prevention of overcharging, a current cut-off mechanism capable of detecting the internal pressure of the battery to cut off the current may be provided in the battery cap.

### [Second Energy Storage Device (Electric Double Layer Capacitor)]

The second energy storage device of the present invention is an energy storage device including the nonaqueous electrolytic solution of the present invention and storing energy by utilizing an electric double layer capacitance in an interface between the electrolytic solution and an electrode. One example of the present invention is an electric double layer capacitor. One of the most typical electrode active materials which are used in this energy storage device is active carbon. The double layer capacitance is increased substantially in proportion to the surface area.

### [Third Energy Storage Device]

The third energy storage device of the present invention is an energy storage device including the nonaqueous electrolytic solution of the present invention and storing energy by utilizing a doping/dedoping reaction of the electrode. Examples of the electrode active material that is used in this energy storage device include a metal oxide, such as ruthenium oxide, iridium oxide, tungsten oxide, molybdenum oxide, copper oxide, etc., and a π-conjugated polymer, such as polyacene, a polythiophene derivative, etc. A capacitor including such an electrode active material is capable of storing energy involving the doping/dedoping reaction of the electrode.

### [Fourth Energy Storage Device (Lithium Ion Capacitor)]

The fourth energy storage device of the present invention is an energy storage device including the nonaqueous electrolytic solution of the present invention and storing energy by utilizing intercalation of lithium ions into a carbon material, such as graphite, etc., as the negative electrode. This energy storage device is called a lithium ion capacitor (LIC). Examples of the positive electrode include one utilizing an electric double layer between an active carbon electrode and an electrolytic solution, one utilizing a doping/dedoping reaction of a it-conjugated polymer electrode, and the like. The electrolytic solution contains at least a lithium salt, such as LiPF₆, etc.

### EXAMPLES

### Examples 1 to 15 and Comparative Examples 1 to 4

### [Production of Lithium Ion Secondary Battery]

93% by mass of LiNi_{0.6}Mn_{0.2}Co_{0.2}O₂ and 4% by mass of acetylene black (electroconductive agent) were mixed, and added to and mixed with a solution which was previously prepared by dissolving 3% by mass of polyvinylidene fluoride (binder) in 1-methyl-2-pyrrolidone, thereby preparing a positive electrode mixture paste. This positive electrode mixture paste was applied onto one surface of an aluminum foil (collector), dried, and treated under pressure, followed by cutting into a predetermined size, thereby producing a positive electrode sheet in a rectangular form. The density of the positive electrode except for the collector was 3.6 g/cm³.

8% by mass of elemental silicon, 82% by mass of artificial graphite (d₀₀₂=0.335 nm, negative electrode active material), and 5% by mass of acetylene black (electroconductive agent) were mixed, and added to and mixed with a solution which was previously prepared by dissolving 5% by mass of polyvinylidene fluoride (binder) in 1-methyl-2-pyrrolidone, thereby preparing a negative electrode mixture paste. This negative electrode mixture paste was applied onto one surface of a copper foil (collector), dried, and treated under pressure, followed by cutting into a predetermined size, thereby producing a negative electrode sheet. The density of the negative electrode except for the collector was 1.5 g/cm³. This electrode sheet was analyzed by X-ray diffractometry. As a result, the ratio [I(110)/I(004)] of the peak intensity I(110) of the (110) plane to the peak intensity I(004) of the (004) plane of the graphite crystal was 0.1.

The positive electrode sheet, a micro-porous polyethylene film-made separator, and the negative electrode sheet were laminated in this order, and a nonaqueous electrolytic solution having each composition shown in Tables 1 to 3 was added, thereby producing a laminate-type battery.

### [Evaluation of High-Temperature Storage Property]

### <Initial Discharge Capacity>

In a thermostatic chamber at 25° C., a laminate-type battery produced by the aforementioned method was charged up to a final voltage of 4.3 V with a constant current of 1 C and under a constant voltage for 3 hours and then discharged down to a final voltage of 2.7 V with a constant current of 1 C, thereby determining the initial discharge capacity.

### <High-Temperature Storage Test>

Subsequently, in a thermostatic chamber at 60° C., this laminated battery was charged up to a final voltage of 4.3 V with a constant current of 1 C and under a constant voltage for 3 hours, and then stored for 7 days while being kept at 4.3 V. Thereafter, the battery was placed in a thermostatic chamber at 25° C., and once discharged down under a constant current of 1 C to a final voltage of 2.7 V.

<Capacity Retention Rate after High-Temperature Storage>

The capacity retention rate after high-temperature storage was determined by the following expression.

Capacity retention rate after high-temperature storage (%)=(Discharge capacity after high-temperature storage)/(Initial discharge capacity)×100

### [Evaluation of Low-Temperature Cycle Property]

### <Low-Temperature Cycle Capacity Retention Rate>

In a thermostatic chamber at 0° C., a laminate-type battery produced by the method described above was charged up to a final voltage of 4.3 V with a constant current of 1 C and under a constant voltage for 3 hours, and then discharged down to a discharge voltage of 3.0 V with a constant current of 1 C. This procedure was taken as one cycle and repeated until 200 cycles were achieved. Then, the low-temperature cycle capacity retention rate was determined by the following expression.

Low-temperature cycle capacity retention rate (%)=(Discharge capacity at 200th cycle)/(Discharge capacity at first cycle)×100

TABLE 1

| | | | | Capacity | Low- |
|---|---|---|---|---|---|
| | | | | retention | temperature |
| | | | | rate after | cycle |
| | Composition of electrolyte salt | | | high- | capacity |
| | Composition of nonaqueous | | | temperature | retention |
| | electrolytic solution | | Content | storage | rate |
| | (Volume ratio of solvents) | Compound | (mass %) | (%) | (%) |
| Example 1 Example 2 Example 3 Example 4 | 1.3M LiPF₆ EC/DMC/MEC (25/65/10) 1.3M LiPF₆ EC/VC/DMC/MEC (23/2/65/10) 1.3M LiPF₆ EC/VC/DMC/MEC (23/2/65/10) 1.3M LiPF₆ EC/VC/DMC/MEC | 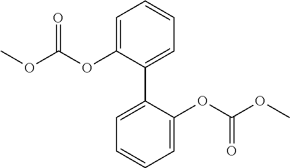 | 2 0.05 0.5 2 | 72 75 76 79 | 75 74 76 79 |
| | (23/2/65/10) | | | | |
| Example 5 | 1.3M LiPF₆ | | 3.5 | 77 | 78 |
| | EC/VC/DMC/MEC | | | | |
| | (23/2/65/10) | | | | |
| Example 6 | 1.3M LiPF₆ EC/VC/DMC/MEC (23/2/65/10) | 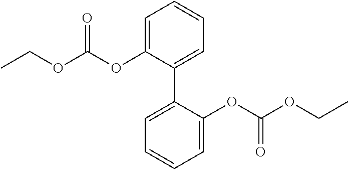 [SMILES: CCOC(=O)Oc1ccccc1-c1ccccc1OC(=O)OCC] | 2 | 75 | 77 |
| Comparative | 1.3M LiPF₆ | None | — | 60 | 64 |
| Example 1 | EC/VC/DMC/MEC | | | | |
| | (23/2/65/10) | | | | |
| Comparative Example 2 | 1.3M LiPF₆ EC/VC/DMC/MEC (23/2/65/10) | 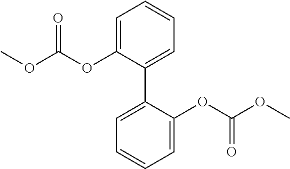 | 5 | 66 | 68 |
| Comparative Example 3 | 1.3M LiPF₆ EC/VC/DMC/MEC (23/2/65/10) | 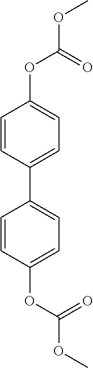 [SMILES: COC(=O)Oc1ccc(-c2ccc(OC(=O)OC)cc2)cc1] | 2 | 61 | 64 |
| Comparative Example 4 | 1.3M LiPF₆ EC/VC/DMC/MEC (23/2/65/10) | 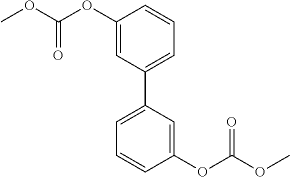 | 2 | 62 | 66 |

TABLE 2

| | | | | Capacity | Low- |
|---|---|---|---|---|---|
| | | | | retention | temperature |
| | | | | rate after | cycle |
| | Composition of electrolyte salt | | | high- | capacity |
| | Composition of nonaqueous | | | temperature | retention |
| | electrolytic solution | | Content | storage | rate |
| | (Volume ratio of solvents) | Compound | (mass %) | (%) | (%) |
| Example 7 Example 8 Example 9 Example 10 | 1.25M LiPF₆ + 0.05M LES EC/FEC/VC/DMC/MEC (18/5/2/65/10) 1.25M LiPF₆ + 0.05M LiPO₂F₂ EC/FEC/VC/DMC/MEC (18/5/2/65/10) 1.25M LiPF₆ + 0.05M LiDFOP EC/FEC/VC/DMC/MEC (18/5/2/65/10) 0.85M LiPF₆ + 0.45M LiFSI EC/FEC/VC/DMC/MEC | 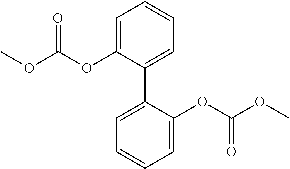 | 1 1 1 1 | 80 82 84 81 | 83 84 86 82 |
| | (18/5/2/65/10) | | | | |
| Example 11 | 1.275M LiPF₆ + 0.025M LiTOD | | 1 | 83 | 85 |
| | FC/FEC/VC/DMC/MEC | | | | |
| | (18/5/2/65/10) | | | | |

TABLE 3

| | | | | | Capacity | Low- |
|---|---|---|---|---|---|---|
| | | | | | retention | temperature |
| | | | | | rate after | cycle |
| | Composition of electrolyte salt | | | Content of | high- | capacity |
| | Composition of nonaqueous | | | other | temperature | retention |
| | electrolytic solution | | Content | additive | storage | rate |
| | (Volume ratio of solvents) | Compound | (mass %) | (mass %) | (%) | (%) |
| Example 12 Example 13 Example 14 Example 15 | 1.25M LiPF₆ EC/VC/DMC/MEC/EP (29/1/35/25/10) 1.25M LiPF₆ EC/VC/DMC/MEC/EP (29/1/35/25/10) 1.25M LiPF₆ EC/VC/DMC/MEC/EP (29/1/35/25/10) 1.25M LiPF₆ EC/VC/DMC/MEC/EP | 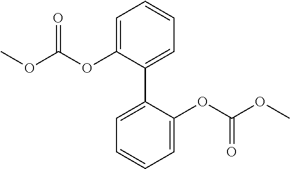 | 1 1 1 1 | adiponitrile (1) ethylene sulfate (1) 1,3-dioxane (1) succinic anhydride | 82 84 81 81 | 80 81 81 80 |
| | (29/1/35/25/10) | | | (1) | | |

### Example 16 and Comparative Example 5

Positive electrode sheets were produced using LiNi_{0.5}Mn_{1.5}O₄ (positive electrode active material) in place of the positive electrode active material used in Example 4 and Comparative Example 1.

94% by mass of LiNi_{0.5}Mn_{1.5}O₄ and 3% by mass of acetylene black (electroconductive agent) were mixed, and added to and mixed with a solution which was previously prepared by dissolving 3% by mass of polyvinylidene fluoride (binder) in 1-methyl-2-pyrrolidone, thereby preparing a positive electrode mixture paste.

Laminate-type batteries were produced and battery evaluations were performed in the same manner as in Example 4 and Comparative Example 1, except that this positive electrode mixture paste was applied onto one surface of an aluminum foil (collector), dried, and treated under pressure, followed by cutting into a predetermined size, thereby producing a positive electrode sheet, that the final charging voltage was 4.85V and the final discharging voltage was 3.0 V in the battery evaluations, and that the composition of the nonaqueous electrolytic solution was changed to a prescribed one. The results are shown in Table 4.

TABLE 4

| | | | | Capacity | Low- |
|---|---|---|---|---|---|
| | | | | retention | temperature |
| | | | | rate after | cycle |
| | Composition of electrolyte salt | | | high- | capacity |
| | Composition of nonaqueous | | | temperature | retention |
| | electrolytic solution | | Content | storage | rate |
| | (Volume ratio of solvents) | Compound | (mass %) | (%) | (%) |
| Example 16 | 1.3M LiPF₆ EC/FEC/DMC/MTFEC (15/10/30/45) | 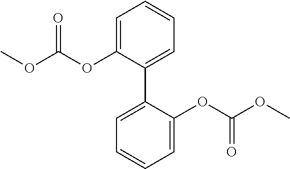 | 2 | 61 | 68 |
| Comparative | 1.3M LiPF₆ | None | — | 52 | 61 |
| Example 5 | EC/FEC/DMC/MTFEC | | | | |
| | (15/10/30/45) | | | | |

### Example 17 and Comparative Example 6

Negative electrode sheets were produced using lithium titanate Li₄Ti₅O₁₂ (negative electrode active material) in place of the negative electrode active material used in Example 4 and Comparative Example 1.

80% by mass of lithium titanate Li₄Ti₅O₁₂ and 15% by mass of acetylene black (electroconductive agent) were mixed, and added to and mixed with a solution which was previously prepared by dissolving 5% by mass of polyvinylidene fluoride (binder) in 1-methyl-2-pyrrolidone, thereby preparing a negative electrode mixture paste.

Laminate-type batteries were produced and battery evaluations were performed in the same manner as in Example 4 and Comparative Example 1, except that this negative electrode mixture paste was applied onto one surface of a copper foil (collector), dried, and treated under pressure, followed by cutting into a predetermined size, thereby producing a negative electrode sheet, that the final charging voltage was 2.8 V and the final discharging voltage was 1.2 V in the battery evaluations, and that the composition of the nonaqueous electrolytic solution was changed to a prescribed one. The results are shown in Table 5.

TABLE 5

| | | | | Capacity | Low- |
|---|---|---|---|---|---|
| | | | | retention | temperature |
| | | | | rate after | cycle |
| | Composition of electrolyte salt | | | high- | capacity |
| | Composition of nonaqueous | | | temperature | retention |
| | electrolytic solution | | Content | storage | rate |
| | (Volume ratio of solvents) | Compound | (mass %) | (%) | (%) |
| Example 17 | 1.3M LiPF₆ PC/DMC/MEC (30/50/20) | 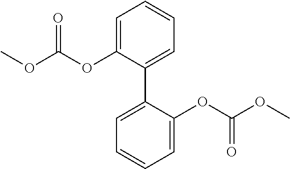 | 2 | 86 | 85 |
| Comparative | 1.3M LiPF₆ | None | — | 77 | 79 |
| Example 6 | PC/DMC/MEC | | | | |
| | (30/50/20) | | | | |

All the lithium secondary batteries of Examples 1 to 15 mentioned above showed improved cycle property at a high temperature, as compared with the lithium secondary batteries of Comparative Example 1 where the compound represented by the general formula (I) was not added, of Comparative Example 2 where an excessive amount of the compound represented by the general formula (I) was added, and of Comparative Example 3 where the compound disclosed in JP-A-2000-294279 was added.

As can be seen from the comparison between Example 16 and Comparative Example 5 and the comparison between Example 17 and Comparative Example 6, similar effects were exhibited also in the case where nickel manganite lithium salt (LiNi_{1/2}Mn_{3/2}O₄) was used as a positive electrode and the case where lithium titanate (Li₄Ti₅O₁₂) was used as a negative electrode. Consequently, the effect of the present invention is obviously independent of a specific positive electrode and negative electrode.

Furthermore, the nonaqueous electrolytic solution of the present invention has an effect of improving the discharging property of a lithium primary battery when the battery is used in a wide temperature range.

An energy storage device including the nonaqueous electrolytic solution of the present invention is useful as an energy storage device, such as a lithium secondary battery, etc., that is excellent in electrochemical characteristics when the device is used in a wide temperature range.

What is claimed is:

1. A nonaqueous electrolytic solution having an electrolyte salt dissolved in a nonaqueous solvent, the nonaqueous electrolytic solution comprising 0.01 to 4% by mass of a compound represented by the following general formula (I): 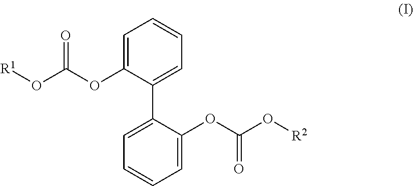
wherein R¹ and R² each independently represent a methyl group, an ethyl group, or a fluoroethyl group.

2. The nonaqueous electrolytic solution according to claim 1, wherein the compound represented by the general formula (I) is one or two selected from (1,1′-biphenyl)-2,2′-diyl dimethyl bis(carbonate), and (1,1′-biphenyl)-2,2′-diyl diethyl bis(carbonate).

3. The nonaqueous electrolytic solution according to claim 1, wherein the nonaqueous solvent comprises a cyclic carbonate and a linear ester.

4. The nonaqueous electrolytic solution according to claim 3, wherein the cyclic carbonate comprises one or more selected from ethylene carbonate, propylene carbonate, 4-fluoro-1,3-dioxolan-2-one, vinylene carbonate, and 4-ethynyl-1,3-dioxolan-2-one.

5. The nonaqueous electrolytic solution according to claim 3, wherein the linear ester comprises both a symmetric linear carbonate and an asymmetric linear carbonate, and the content of the symmetric linear carbonate is larger than the content of the asymmetric linear.

6. The nonaqueous electrolytic solution according to claim 3, wherein the linear ester comprises one or more selected from one or more asymmetric linear carbonates selected from the group consisting of methyl ethyl carbonate, methyl propyl carbonate, methyl isopropyl carbonate, methyl butyl carbonate, and ethyl propyl carbonate; one or more symmetric linear carbonates selected from the group consisting of dimethyl carbonate, diethyl carbonate, dipropyl carbonate, and dibutyl carbonate; and one or more linear carboxylate selected from the group consisting of methyl pivalate, ethyl pivalate, propyl pivalate, methyl propionate, ethyl propionate, propyl propionate, methyl acetate, and ethyl acetate.

7. The nonaqueous electrolytic solution according to claim 1, wherein the nonaqueous electrolytic solution further comprises one or more lithium salts selected from the group consisting of a lithium salt having a oxalate structure, a lithium salt having a phosphate structure, a lithium salt having a S═O group, and a lithium salt composed of a lithium cation with an ether compound selected from 2,5,8,11-tetraoxadodecane and 2,5,8,11,14-pentaoxapentadecane as a ligand and a difluorophosphate anion, and a total content of the lithium salts in the nonaqueous electrolytic solution is preferably 0.001 mol/L to 0.5 mol/L.

8. The nonaqueous electrolytic solution according to claim 7, wherein the lithium salt having a oxalate structure is one or more selected from the group consisting of lithium bis(oxalate)borate, lithium difluoro(oxalate)borate, lithium tetrafluoro(oxalate)phosphate, and lithium difluorobis(oxalate)phosphate.

9. The nonaqueous electrolytic solution according to claim 7, wherein the lithium salt having a phosphate structure is one or more selected from the group consisting of LiPO₂F₂ and Li₂PO₃F.

10. The nonaqueous electrolytic solution according to claim 7, wherein the lithium salt having a S═O group is one or more selected from the group consisting of lithium trifluoro((methanesulfonyl)oxy)borate, lithium pentafluoro((methanesulfonyl)oxy)phosphate, lithium methylsulfate, lithium ethylsulfate, lithium 2,2,2-trifluoroethylsulfate, and FSO₃Li.

11. The nonaqueous electrolytic solution according to claim 1, wherein the electrolyte salt comprises one or more selected from the group consisting of LiPF₆, LiBF₄, LiN(SO₂CF₃)₂, LiN(SO₂C₂F₅)₂, and LiN(SO₂F)₂.

12. The nonaqueous electrolytic solution according to claim 1, which is a nonaqueous electrolytic solution for an energy storage device.

13. An energy storage device comprising a positive electrode, a negative electrode, and a nonaqueous electrolytic solution having an electrolyte salt dissolved in a nonaqueous solvent, wherein the nonaqueous electrolytic solution comprises 0.01 to 4% by mass of a compound represented by the following general formula (I): 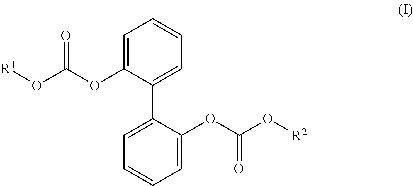
wherein R¹ and R² each independently represent a methyl group, an ethyl group, or a fluoroethyl group.

14. The energy storage device according to claim 13, wherein the compound represented by the general formula (I) is one or two selected from (1,1′-biphenyl)-2,2′-diyl dimethyl bis(carbonate), and (1,1′-biphenyl)-2,2′-diyl diethyl bis(carbonate).

15. The energy storage device according to claim 13, wherein the nonaqueous solvent comprises a cyclic carbonate and a linear ester.

16. The energy storage device according to claim 13, wherein the positive electrode comprises a complex metal oxide containing lithium and one or more selected from the group consisting of cobalt, manganese, and nickel, or a lithium-containing olivine-type phosphate containing one or more selected from the group consisting of iron, cobalt, nickel, and manganese, as a positive electrode active material.

17. The energy storage device according to claim 13, wherein the negative electrode comprises one or more selected from metal lithium, a lithium alloy, a carbon material capable of absorbing and releasing lithium ions, elemental tin, a tin compound, elemental silicon, a silicon compound, and a lithium titanate compound, as a negative electrode active material.
